(19) United States
(12) Patent Application Publication
(10) Pub. No.: US 2025/0335000 A1
(43) Pub. Date: Oct. 30, 2025

(54) SYSTEM AND METHOD FOR CLOCK SYNCHRONIZATION AND TIME TRANSFER BETWEEN QUANTUM ORCHESTRATION PLATFORM ELEMENTS

(71) Applicant: Q.M Technologies Ltd., Tel Aviv-Yafo (IL)

(72) Inventors: Itamar Sivan, Tel Aviv-Yafo (IL); Yonatan Cohen, Tel Aviv-Yafo (IL); Nissim Ofek, Tel Aviv-Yafo (IL); Asaf Rozen, Tel Aviv-Yafo (IL); Guy Osi, Tel Aviv-Yafo (IL); Ramon Szmuk, Bordeaux (FR)

(21) Appl. No.: 19/210,068

(22) Filed: May 16, 2025

Related U.S. Application Data
(63) Continuation of application No. 17/381,270, filed on Jul. 21, 2021, now Pat. No. 12,332,682.

(51) Int. Cl. G06F 1/12

(52) U.S. Cl. CPC G06F 1/12

(57) ABSTRACT

A quantum orchestration platform (QOP) comprises a collection of processing units and analog components that produce synchronized analog pulses, readouts, and computations that may be used for operations with qubits. All processing units of the QOP are synchronized with minimal skew via time processing over one or more sync cables that interconnect the processing units.

### BACKGROUND

Limitations and disadvantages of conventional quantum control will become apparent to one of skill in the art, through comparison of such approaches with some aspects of the present method and system set forth in the remainder of this disclosure with reference to the drawings.

### BRIEF SUMMARY

Methods and systems are provided for clock synchronization and time transfer between quantum orchestration platform elements, substantially as illustrated by and/or described in connection with at least one of the figures, as set forth more completely in the claims.

### BRIEF DESCRIPTION OF THE DRAWINGS

FIG. 1 illustrates a system for distributing clocking information in accordance with various example implementations of this disclosure.

FIG. 2 illustrates sampling waveforms in accordance with various example implementations of this disclosure.

FIG. 3 illustrates system for estimating a phase difference between two signals in accordance with various example implementations of this disclosure.

FIG. 4 illustrates a flowchart of an example method for clock synchronization in accordance with various example implementations of this disclosure.

FIG. 5 illustrates a flowchart of an example method for time transfer in accordance with various example implementations of this disclosure.

FIG. 6 illustrates a ring topology that is operable to minimize phase error in accordance with various example implementations of this disclosure.

FIG. 7 illustrates a two dimensional ring topology that is operable to minimize phase error among a large number of devices in accordance with various example implementations of this disclosure.

### DETAILED DESCRIPTION

Classical computers operate by storing information in the form of binary digits (“bits”) and processing those bits via binary logic gates. At any given time, each bit takes on only one of two discrete values: 0 (or “off”) and 1 (or “on”). The logical operations performed by the binary logic gates are defined by Boolean algebra and circuit behavior is governed by classical physics. In a modern classical system, the circuits for storing the bits and realizing the logical operations are usually made from electrical wires that can carry two different voltages, representing the 0 and 1 of the bit, and transistor-based logic gates that perform the Boolean logic operations.

Logical operations in classical computers are performed on fixed states. For example, at time 0 a bit is in a first state, at time 1 a logic operation is applied to the bit, and at time 2 the bit is in a second state as determined by the state at time 0 and the logic operation. The state of a bit is typically stored as a voltage (e.g., 1 V_{dc} for a “1” or 0 V_{dc} for a “0”). The logic operation typically comprises of one or more transistors.

Obviously, a classical computer with a single bit and single logic gate is of limited use, which is why modern classical computers with even modest computation power contain billions of bits and transistors. That is to say, classical computers that can solve increasingly complex problems inevitably require increasingly large numbers of bits and transistors and/or increasingly long amounts of time for carrying out the algorithms. There are, however, some problems which would require an infeasibly large number of transistors and/or infeasibly long amount of time to arrive at a solution. Such problems are referred to as intractable.

Quantum computers operate by storing information in the form of quantum bits (“qubits”) and processing those qubits via quantum gates. Unlike a bit which can only be in one state (either 0 or 1) at any given time, a qubit can be in a superposition of the two states at the same time. More precisely, a quantum bit is a system whose state lives in a two dimensional Hilbert space and is therefore described as a linear combination α|0 [symbol] +β|1 [symbol] , where |0 [symbol] and |1 [symbol] are two basis states, and α and β are complex numbers, usually called probability amplitudes, which satisfy |α|²+|β|²=1. Using this notation, when the qubit is measured, it will be 0 with probability |α|² and will be 1 with probability |β|². The basis states |0 [symbol] and |1 [symbol] can also be represented by two-dimensional basis vectors [₀¹] and [₁⁰], respectively. In this notation, the qubit state may be represented by [_{β}^{α}]. The operations performed by the quantum gates are defined by linear algebra over Hilbert space and circuit behavior is governed by quantum physics. This extra richness in the mathematical behavior of qubits and the operations on them, enables quantum computers to solve some problems much faster than classical computers. In fact, some problems that are intractable for classical computers may become trivial for quantum computers.

Unlike a classical bit, a qubit cannot be stored as a single voltage value on a wire. Instead, a qubit is physically realized using a two-level quantum mechanical system. For example, at time 0 a qubit is described as [symbol] , at time 1 a logic operation is applied to the qubit, and at time 2 the qubit is described as [symbol] . Many physical implementations of qubits have been proposed and developed over the years. Some examples of qubits implementations include superconducting circuits, spin qubits, and trapped ions.

A quantum orchestration platform (QOP) comprises a collection of processing units and analog components that produce synchronized analog pulses, readouts, and computations that may be used for operations with qubits. To pulse simultaneously, all elements of the QOP must have their internal clocks synchronized with minimal skew. In addition, a reliable message distribution system is needed to command all units to start playing pulses simultaneously at some point in time. However, the QOP is modular and comprises individual units, where the length of cables connecting the different units may be arbitrary. This makes the task of distributing a common clock between all units challenging, as the latency of different cables is unknown and subject to environmental changes.

A system for clock synchronization comprises a first processing unit operable at a first clock, a second processing unit operable at a second clock, and a sync line operably coupled between the first processing unit and the second processing unit. The first clock may be provided by a system clock via a first variable delay. The second clock may be provided by the system clock via a second variable delay. The first processing unit is operable to send the first clock to the second processing unit via the sync line. The second processing unit is operable to send the second clock to the first processing unit via the sync line. The second processing unit is operable to generate a first phase difference between the first clock as received and the second clock. The first processing unit is operable to generate a second phase difference between the second clock as received and the first clock. The first variable delay is adjustable according to the first phase difference and the second phase difference. The second variable delay is adjustable according to the first phase difference and the second phase difference.

The first processing unit comprises a first sampling circuit that is operable according to a sample clock. The second processing unit comprises a second sampling circuit that is operable according to the sample clock. The sample clock is at different frequency than the system clock. A sample clock frequency may be, for example, 0.1% greater than a system clock frequency.

The first processing unit and the second processing unit each comprise an XOR gate operable to perform an exclusive OR operation between a sampled first clock and a sampled second clock. The first processing unit and the second processing unit each comprise an averaging circuit operably coupled to an XOR output. The first processing unit and the second processing unit are each operable to determine a duty cycle of a sampled first clock and a duty cycle of a sampled second clock.

The system for clock synchronization may also be used for time transfer, where the first processing unit comprises a first time counter that increments according to a first clock, and the second processing unit comprises a second time counter that increments according to a second clock.

The first processing unit is operable to send a first message to the second processing unit via the sync line cable. The first message comprises a first timestamp according to the first time counter. The second processing unit is also operable to send a second message to the first processing unit via the sync line cable. The second message comprises a second timestamp according to the second time counter. The second processing unit is operable to generate a first timestamp difference according to the first message as received and the second time counter upon arrival of the first message. The first processing unit is also operable to generate a second timestamp difference according to the second message as received and the first time counter upon arrival of the second message.

The first clock is adjustable according to the first timestamp difference and the second timestamp difference. The second clock is also adjustable according to the first timestamp difference and the second timestamp difference.

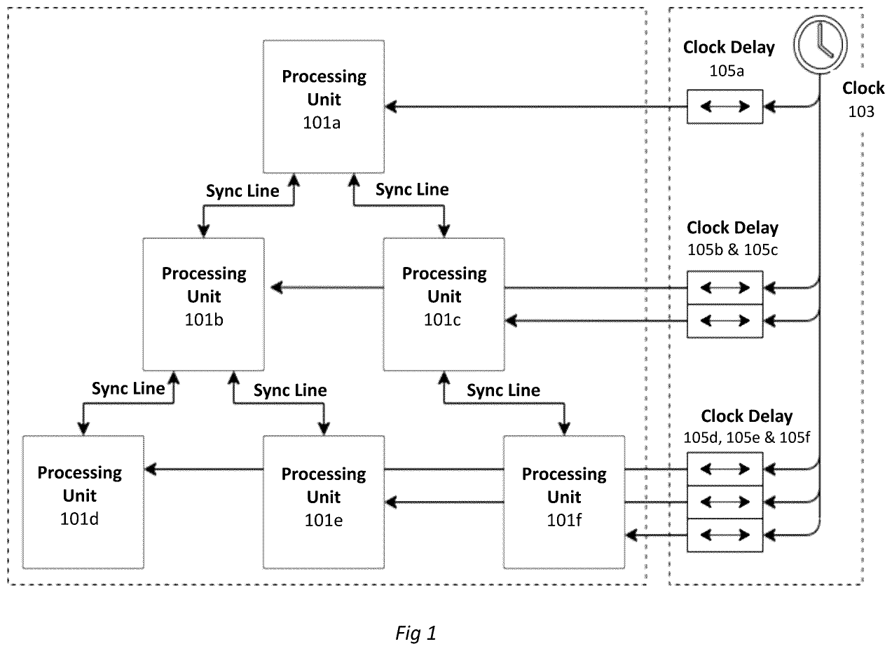

FIG. 1 illustrates a system for distributing clocking information in accordance with various example implementations of this disclosure. The operation of this system is independent of the length of cables used. The system of FIG. 1 comprises six processing units 101a-101f and a common clock 103. Note, the scope his disclosure is not limited to six processing units.

In the system of FIG. 1, the clock phase information is distributed through a hierarchy of units 101a-101f, where each unit (e.g., 101b) has at most one master (e.g., 101a) and one or more slaves (e.g., 101d and 101e). At each stage, a slave unit (e.g., 101b) will sync its clock phase to its master unit (e.g., 101a), from the upper-most of the hierarchy up to the bottom. Then, messages will be passed between the units 101a-101f to sync their respective timestamp.

Synchronization and communication between any two of the units 101a-101f are established through a single Sync Line cable between them and a shift-capable clock input. The common clock 103 is supplied to each of the units 101a-101f via each of a plurality of clock delays 105a-101f respectively.

To synchronize two units, for example, unit A 101a forwards its system clock to unit B 101b through the common Sync Line cable, while unit B 101b measures the phase difference between the Sync Line cable signal and its system clock supplied via clock delay 105b. Next, unit B 101b forwards its clock to the common Sync Line cable, while unit A 101a measures the phase difference between the Sync Line cable signal and its system clock supplied via clock delay 105b.

Due to symmetric propagation delay through the common cable, the system clock of unit B can be shifted via clock delay 105b to the point where both units measure the same phase in the two measurements. At this point, the clock phase of the two units 101a and 101b is synced or shifted by exactly a half-cycle of the clock. This common Sync Line cable is also used to synchronize a timestamp of the two units 101a and 101b, by sending a message back and forth and marking the local time of each event on each unit.

For example, suppose that the two units 101a and 101b have a timestamp difference of 100 clock cycles, and the propagation delay of the cable is 2 cycles. The first unit 101a will send a message at local time 0 to arrive at the second unit 101b at local time 102. The second unit 101b will send a message back to the first unit 101a at local time 1000, to arrive at local time 902. From these 4 numbers (0, 102, 1000, 902) the timestamp difference of 100 can be extracted. This message handshake also resolves the ambiguity of the half-cycle by returning a timestamp difference with a half-cycle resolution.

The phase difference between two different signals is measured by sampling both clocks with a third clock that has a similar but not exact frequency to the two, then operating an XOR between the sampled data, and finally averaging the outcome. Using the same scheme it is possible to determine the duty cycle of each input clock port, which is needed to further improve the estimated phase difference between the inputs.

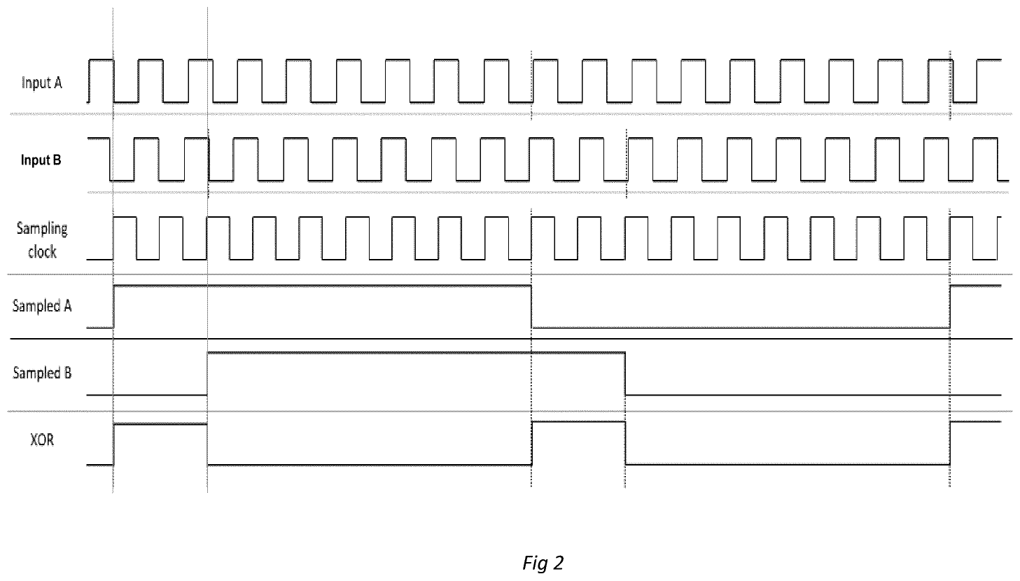

FIG. 2 illustrates sampling waveforms in accordance with various example implementations of this disclosure. For example, to compare two 250 MHz signals (Input A and Input B), these signals are sampled with a 250.25 MHz sampling clock. This sampling measurement is equivalent to sampling the original clock with a resolution of 1000 samples per cycle, which provides sufficient resolution when performing an XOR operation between the two sampled signals. The duty cycle of the XOR result may be estimated by, for example, an exponential moving average. The value from the averaged XOR indicates the absolute value of the phase difference between the two signals (Input A and Input B) probed. When sweeping the phase delay, this information may determine the point at which the two clocks (corresponding to Input A and Input B) are aligned after the associated delay line. By finding the alignment point for the two clock forwarding types (A to B and B to A), it is possible to find the point on which the two local clocks (corresponding to Input A and Input B) are synced, up to a half-cycle ambiguity.

To eliminate electronic sources of noise, the cable connecting the different units may be AC coupled. Messages transmitted between units may be encoded by XOR'ing the data with a clock at half the frequency of the system clock. The encoded message may be captured by setting a capture clock frequency to the system clock, with a phase-shift calibrated to sample the message robustly.

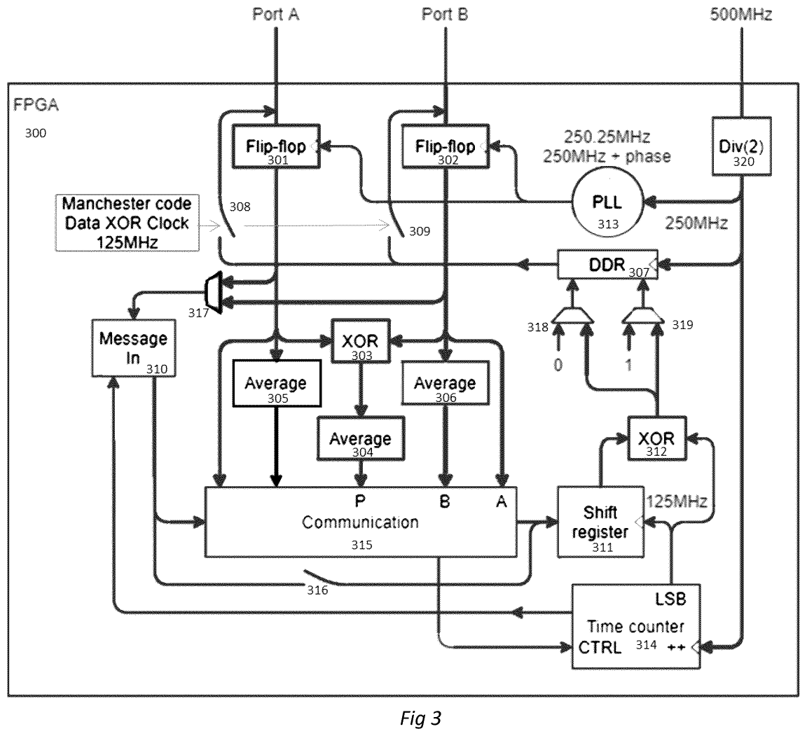

FIG. 3 illustrates system 300 for estimating a phase difference between two signals (Input A and Input B) in accordance with various example implementations of this disclosure. The system 300 in FIG. 3 may be implemented using discrete logic gates, an ASIC or an FPGA.

The signals may comprise clocks and/or messages. When capturing incoming messages, an onboard PLL 313 provides the sampling clock tuned to match the system clock with a programmable phase. As a phase meter used to synchronize the clocks, the PLL 313 provides a frequency close but not equal to the system clock. The PLL 313 may be fed by a 250 MHz system clock that is generated by a 500 MHz clock Divided by 2 320. At the end of the disclosed process, the 250 MHz clock is synced at a point close to the port IO.

Flip-flops 301 and 302 capture incoming and outgoing signals at Port A and Port B respectively. An incoming message is parsed and timestamped. An outgoing message is timestamped as well. Incoming signals to the two flip-flops 301 and 302 are sampled using the PLL 313 at 250.25 MHz, for example. The signals from the two flip-flops 301 and 302 are XOR'ed 303 and averaged 304. The signals directly from the two flip-flops 301 and 302 are multiplexed 317 and sent 310 to communication block 315. Mux 317 is operable to choose the incoming data lane. The signals directly from the two flip-flops 301 and 302 are also averaged by averaging circuits 305 and 306, respectively, to obtain the duty cycle in communication block 315. The communication block 315 may comprise a processor to orchestrate the operation.

A message output from the communication block 315 enters the shift register 311 and is encoded. Manchester encoding is performed by XOR'ing 312 the shift register 311 output with a clock at 125 MHz, for example. A phase difference between two clocks is determined according to the Manchester encoding.

Mux 318 and mux 319 are operable to select between an output of a 250 MHz clock or the Manchester encoded message at 125 MHz.

Port A and Port B operate in tri-state via switches 308 and 309, respectively, to set the ports as output ports. Switches 308 and 309 may also allow a repeater mode, where an incoming message from one port will leave from the other. An output path from memory 307 comprising a Manchester-encoded message may be clocked at 125 MHz, for example.

PLL 313 may be set to 250 MHz+phase offset to capture messages, and detect clock shift and divider 320 slip (by measuring incoming clock, which remains unchanged at 250 MHz). The LSB of a Timestamp counter 314 may be used as the 125 MHz clock for messages. The timestamp counter 314 may be controlled to allow a user-defined shift post calibration.

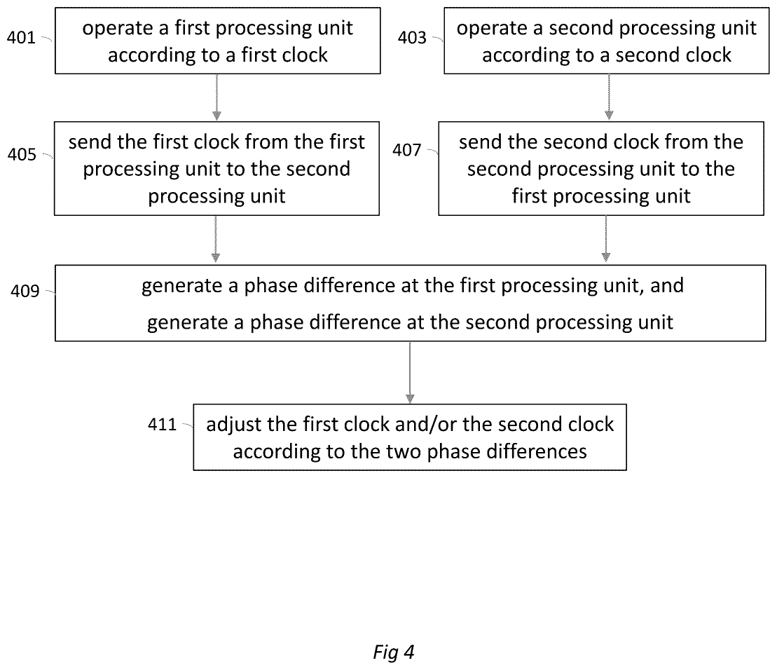

FIG. 4 illustrates a flowchart of an example method for clock synchronization in accordance with various example implementations of this disclosure. The example method for clock synchronization may be used in a QOP comprises a plurality of processing units. For illustration purposes, the plurality of processing units comprise a first processing unit and a second processing unit. The plurality of processing units may comprise additional processing units arranged in a hierarchy as described with respect to FIG. 1.

At 401, a first processing unit operates according to a first clock. Simultaneously at 403, a second processing unit operates according to a second clock. The first clock and the second clock are at a common frequency.

At 405, the first clock is sent from the first processing unit to the second processing unit via a common sync cable. At 407, the second clock is sent from the second processing unit to the first processing unit via the same common sync cable.

At 409, a first phase difference, between the first clock and the second clock is generated at the second processing unit, and a second phase difference, between the first clock and the second clock is generated at the first processing unit. A phase difference generation comprises sampling the first clock and the second clock with a third clock, where the third clock is at a different frequency than the first clock and the second clock. For example, the third clock frequency may be 0.1% greater than the common frequency of the first clock and the second clock. The sampled first clock and the sampled second clock are XOR'ed and averaged to produce a phase difference signal. The duty cycles of the sampled first clock and the sampled second clock are also determined by averaging the sampled first clock and the sampled second clock prior to the XOR.

At 411, one or both of the first clock and the second clock are adjusted according to the first phase difference and the second phase difference. The adjustment may be an advancement (i.e., removal of delay) or an additional delay set via one or more variable delay units.

After the two processing units (101 in FIG. 1) have aligned their phases and shared a timestamp, a link is established for the communication of various messages and operations. Operations may comprise, for example, a command to start, stop, pause or resume execution according to a particular timestamp. Operations may also comprise a recalibration of phase to account for drift. The polarity of the sync line may be alternated to indicate whether a processing unit 101 is transmitting or receiving.

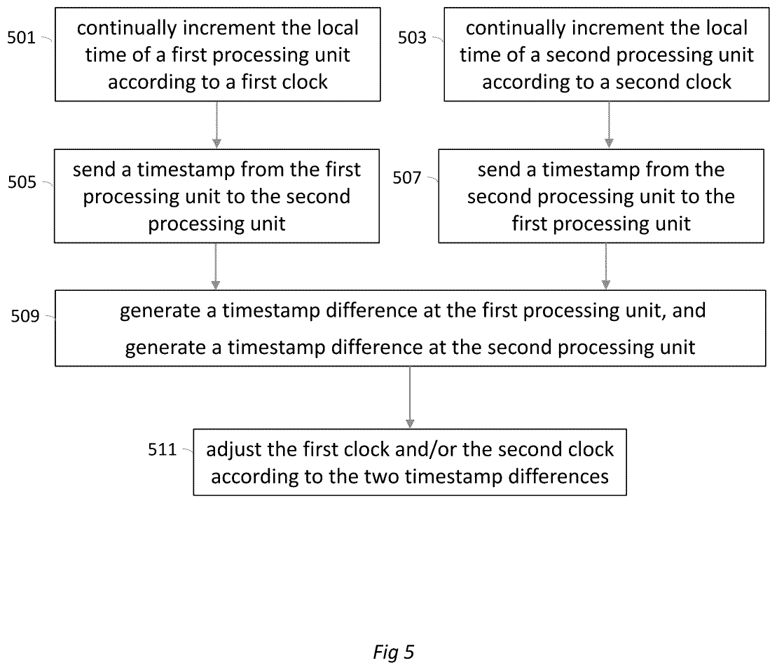

FIG. 5 illustrates a flowchart of an example method for time transfer in accordance with various example implementations of this disclosure. The example method for time transfer may be used in a QOP comprises a plurality of processing units. For illustration purposes, the plurality of processing units comprise a first processing unit and a second processing unit. The plurality of processing units may comprise additional processing units arranged in a hierarchy as described with respect to FIG. 1.

At 501, a first processing unit continually increments a first local time according to a first clock. Simultaneously at 503, a second processing unit continually increments a second local time according to a second clock. The first clock and the second clock operate at a common frequency.

At 505, a first message with a first timestamp is sent from the first processing unit to the second processing unit via a common sync cable. At 507, a second message with a second timestamp is sent from the second processing unit to the first processing unit via the same common sync cable.

At 509, a first timestamp difference, between the first timestamp and the second local time is generated at the second processing unit, and a second timestamp difference, between the second timestamp and the first local time is generated at the first processing unit. The first timestamp difference may be generated by subtracting the first timestamp from an arrival timestamp that is based on the second local time. The second timestamp difference may be generated by subtracting the second timestamp from an arrival timestamp that is based on the first local time.

At 511, one or both of the first clock and the second clock are adjusted according to the first timestamp difference and the second timestamp difference. The adjustment may be an advancement or an additional delay set via one or more variable delay units.

This disclosed system is operable to synchronize a plurality of devices together with a minimum amount of connectivity. Each device in the plurality of devices may have a small phase error/drift (d_err) with respect to the other device it is coupled to. In some situations, the phase error between consecutive devices (d_err) may be smaller than a minimum phase correction step (d_calibrate).

Even after clock synchronization, a phase error (d_err) may remain between two devices if the step size of a clock generator's phase calibration (d_calibrate) is not small enough. In a system that comprises many devices, this phase error may accumulate and cause a significant phase drift between some of the devices. The accumulated phase error between any two devices, of a plurality of devices, may be monitored and utilized to improve synchronization.

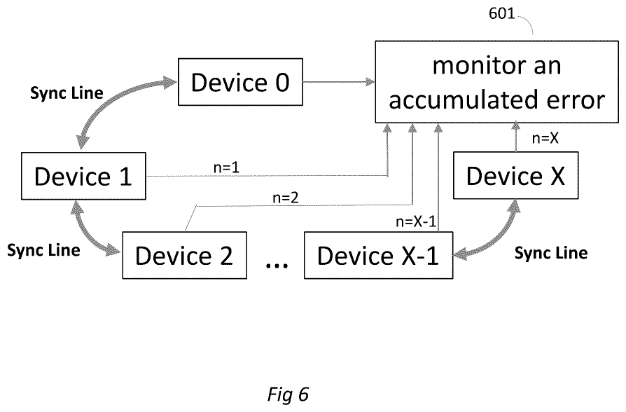

FIG. 6 illustrates a ring topology that is operable to minimize phase error, even when d_err<d_calibrate. The ring topology of FIG. 6 is operable to measure the phase error between two devices. The calibration of every two sequential devices is based on the phase error accumulating in one direction. Therefore, a direct measurement of the phase error between device X and Device 0 will denote the overall accumulated error in a single measurement, allowing a fast and rapid minimization. The error monitor 601 may measures the phase shift between two devices that are directly or indirectly connected.

In a setup of many devices (0 thru X) as illustrated in FIG. 6, the phase of connected devices is monitored directly. The phase error between device 0 and device 2 may be determined by measuring the phase error between device 0 and device 1 and accumulating that phase error with the phase error measured between device 1 and device 2. The monitor 601 may be a physical unit or software.

By using a ring topology, the error between the first device (device 0) and the last device (device X) may be measured directly. Because the error increases between every two devices, the maximal error between device 0 and device X may be measured to determine how many taps/steps of phase correction (d_calibrate) are required. For example, if 3 taps are required to minimize the accumulated phase error, a single tap correction at 0.25, 0.5 and 0.75 of the ring may be made without having to measure all phases.

As illustrated, Device 1 may be connected to Device 0, Device 2 may be connected to Device 1 and so forth up to Device X being connected to Device X−1. An interface 601 between Device X and Device 0 may be used to monitor an accumulated error (X*d_err). According to the accumulated error, the device phases may be adjusted. Alternatively, the phase error between every two devices may be computed. For example, the overall error from Device 0 to Device n is d_err_n. For the first n where d_err_n>d_calibrate, the phase of Device n may be shifted to reduce the overall error by d_calibrate. Every other Device m (n<m<X) may also be shifted to maintain alignment of those devices. A phase error between devices may be corrected in steps. This process of determining when d_err_n>d_calibrate may be repeated until the overall error is minimized.

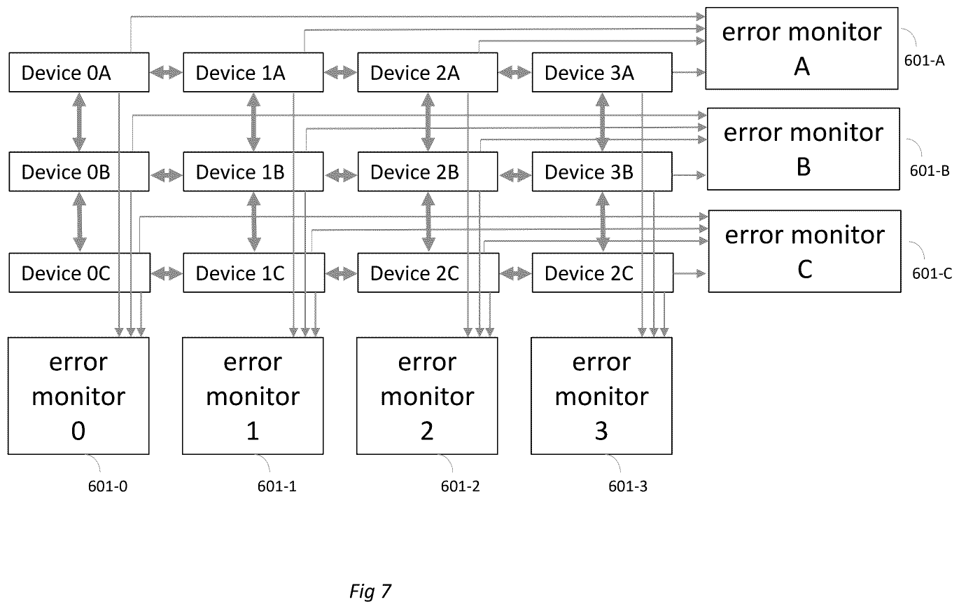

For X*Y devices (Y<X), each group of X devices may establish a ring topology in a first dimension, and each group of Y devices may be connected in a ring topology in a second dimension. FIG. 7 illustrates an example two dimensional ring topology to minimize phase error among a large number of devices. For example, FIG. 7 illustrates a 2-D ring topology with X=4 and Y=3. These dimensions may also be made larger than those illustrated without deviating from the present disclosure. The overall error in every ring (e.g., Rings A, B and C) in a first dimension may be minimized first according to error monitors 601-A, 601-B and 601-C. Then, the overall error in every ring (e.g., Rings 0, 1, 2 and 3) in a second dimension may be minimized according to error monitors 601-0, 601-1, 601-2 and 601-3.

The present method and/or system may be realized in hardware, software, or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical implementation may comprise one or more application specific integrated circuit (ASIC), one or more field programmable gate array (FPGA), and/or one or more processor (e.g., x86, x64, ARM, PIC, and/or any other suitable processor architecture) and associated supporting circuitry (e.g., storage, DRAM, FLASH, bus interface circuits, etc.). Each discrete ASIC, FPGA, Processor, or other circuit may be referred to as “chip,” and multiple such circuits may be referred to as a “chipset.” Another implementation may comprise a non-transitory machine-readable (e.g., computer readable) medium (e.g., FLASH drive, optical disk, magnetic storage disk, or the like) having stored thereon one or more lines of code that, when executed by a machine, cause the machine to perform processes as described in this disclosure. Another implementation may comprise a non-transitory machine-readable (e.g., computer readable) medium (e.g., FLASH drive, optical disk, magnetic storage disk, or the like) having stored thereon one or more lines of code that, when executed by a machine, cause the machine to be configured (e.g., to load software and/or firmware into its circuits) to operate as a system described in this disclosure.

As used herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As used herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As used herein, the term “exemplary” means serving as a non-limiting example, instance, or illustration. As used herein, the terms “e.g.,” and “for example” set off lists of one or more non-limiting examples, instances, or illustrations. As used herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.). As used herein, the term “based on” means “based at least in part on.” For example, “x based on y” means that “x” is based at least in part on “y” (and may also be based on z, for example).

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1-7. (canceled)

8. A system for time transfer comprising:
a first processing unit comprising a first time counter that increments according to a first clock;
a second processing unit comprising a second time counter that increments according to a second clock;
a cable coupled between the first processing unit and the second processing unit, wherein:
the first processing unit is operable to send a first message to the second processing unit via the cable, wherein the first message comprises a first timestamp according to the first time counter;
the second processing unit is operable to send a second message to the first processing unit via the cable, wherein the second message comprises a second timestamp according to the second time counter;
the second processing unit is operable to generate a first timestamp difference according to the first message as received and the second time counter upon arrival of the first message;
the first processing unit is operable to generate a second timestamp difference according to the second message as received and the first time counter upon arrival of the second message;
the first clock is adjustable according to the first timestamp difference and the second timestamp difference; and
the second clock is adjustable according to the first timestamp difference and the second timestamp difference.

9. The system of claim 8, wherein the first clock and the second clock are both at a common frequency.

10. The system of claim 8, wherein a quantum orchestration platform (QOP) comprises the first processing unit and the second processing unit.

11. The system of claim 8, wherein a phase difference between the first clock and the second clock is determined according to Manchester encoding.

12. The system of claim 8, wherein the first processing unit and the second processing unit are operable to communicate an operation over the cable.

13. The system of claim 12, wherein the operation is a phase recalibration.

14. The system of claim 12, wherein a polarity of the cable indicates whether the first processing unit is transmitting the operation or receiving the operation.

15. The system of claim 8, wherein the first processing unit is operable to command the second processing unit to start, stop, pause or resume execution of an operation.

16. The system of claim 15, wherein the command is associated with a particular timestamp.

17-36. (canceled)

37. A method for time transfer comprising:
generating, at a first processing unit, a first local time that increments according to a first clock;
generating, at a second processing unit, a second local time that increments according to a second clock;
forwarding, via a cable, a first message from the first processing unit to the second processing unit, wherein the first message comprises a first timestamp according to the first local time;
generating, at the second processing unit, a first timestamp difference between the first timestamp and the second local time;
forwarding, via the cable, a second message from the second processing unit to the first processing unit, wherein the second message comprises a second timestamp according to the second local time;
generating, at the first processing unit, a second timestamp difference between the second timestamp and the first local time;
adjusting, via a variable delay unit, one or both the first clock and the second clock, wherein the adjusting is according to the first timestamp difference and the second timestamp difference.

38. The method of claim 37, wherein:
the first clock and the second clock are both at a common frequency,
generating the first timestamp difference comprises subtracting the first timestamp from an arrival timestamp, and
the arrival timestamp is generated according to the second local time.

39. The method of claim 37, wherein a quantum orchestration platform (QOP) comprises the first processing unit and the second processing unit.

40. A system, comprising:
a first processing unit comprising a first clock and a first counter incrementing according to the first clock;
a second processing unit comprising a second clock and a second counter incrementing according to the second clock; and
a communication interface coupled between the first processing unit and the second processing unit, wherein:
the first processing unit is operable to transmit a first message comprising a first counter value to the second processing unit,
the second processing unit is operable to determine a first offset value according to the first counter value and the second counter upon receipt of the first message,
the second processing unit is operable to transmit a second message comprising a second counter value to the first processing unit,
the first processing unit is operable to determine a second offset value according to the second counter value and the first counter upon receipt of the second message, and
one or both of the first clock and the second clock are adjustable according to the first offset value and the second offset value to synchronize the first counter and the second counter.

41. The system of claim 40, wherein the communication interface comprises a bidirectional cable.

42. The system of claim 40, wherein the first clock and the second clock operate at a common nominal frequency.

43. The system of claim 40, wherein the synchronization comprises determining a round-trip delay according to the first offset value and the second offset value.

44. The system of claim 40, wherein the adjustment to one or both clocks is performed via a variable delay module within the respective processing unit.

45. The system of claim 40, wherein a quantum orchestration platform comprises the first processing unit and the second processing unit.

46. The system of claim 40, wherein the system comprises a timing control module operable to align operations according to a plurality of synchronized counter values.
